(19) United States
(12) Patent Application Publication
(10) Pub. No.: US 2017/0103011 A1
(43) Pub. Date: Apr. 13, 2017

(54) INFORMATION PROCESSING APPARATUS AND SYSTEM

(71) Applicant: FUJITSU LIMITED, Kawasaki-shi (JP)

(72) Inventor: Keiichi IDA, Susono (JP)

(73) Assignee: FUJITSU LIMITED, Kawasaki-shi (JP)

(21) Appl. No.: 15/246,581

(22) Filed: Aug. 25, 2016

(30) Foreign Application Priority Data
Oct. 7, 2015 (JP) 2015-199322

(51) Int. Cl. G06F 11/36

(52) U.S. Cl. CPC G06F 11/364

(57) ABSTRACT

An information processing apparatus includes a memory and a processor. The memory stores trace information including a string of location information which indicates locations of texts in a source code that correspond to instructions that have already been executed and which stores an execution order of the instructions. The processor detects a substring that appears a plurality of times from the string of location information included in the trace information and determines location information that belongs to a loop and an execution status of the loop. The processor associates, based on the location information that belongs to the loop, the execution status of the loop with the source code and displays the associated information.

### CROSS-REFERENCE TO RELATED APPLICATION

This application is based upon and claims the benefit of priority of the prior Japanese Patent Application No. 2015-199322, filed on Oct. 7, 2015, the entire contents of which are incorporated herein by reference.

### FIELD

The embodiments discussed herein relate to an information processing apparatus and an information processing system.

### BACKGROUND

When developing software, developers often create source codes by using a high-level language that is easily understood by humans. After creating a source code about a group of functions, a developer uses a conversion tool such as a compiler or an interpreter to convert the source code into machine-readable instructions. Next, the instructions are executed, and the software operation is checked. If there is a problem in the software operation, the developer modifies the source code to solve the problem. This work for finding the cause of the problem and modifying the source code is sometimes called “debug.” In debug, finding the cause of the problem is not always easy. In such cases, developers could use a debug tool that assists debug.

For example, a program debug system that assists debug has been proposed. In the proposed program debug system, a compiler generates an object program including a certain function from a source code. With this function, trace information including execution line numbers and data item values is outputted. When the object program is executed, the trace information is generated. In addition, a trace information display means associates the trace information with the source code and displays the associated information on a screen of a display device. In this operation, in response to an instruction inputted by the user, the trace information display means selects one line in the source code and highlights the selected line, such as by changing the color of the selected line or underlying the selected line. In addition, the trace information display means extracts a data item value relating to the selected line from the trace information and displays the extracted data item value on the screen.

There has also been proposed a trace data generation system that performs conversion on a source code so that trace data is quickly acquired. In the proposed trace data generation system, a control variable that affects a control flow is detected from the source code. In addition, a USE-DEF chain that indicates a relationship between definitions of a value of a control variable and at least one corresponding reference is detected. In the trace data generation system, on the basis of the detected control valuable and USE-DEF chain, a statement that does not affect the control flow is removed from the source code. In addition, in the trace data generation system, a statement indicating a counter that counts the number of executions of the control flow and a statement that outputs the counter value are inserted into the source code.

In addition, there has been proposed a trace device that measures the execution time of a certain portion in a program. When executing an object program, the proposed trace device outputs trace information in which line numbers indicating locations in the source code, values indicating the execution numbers of the locations, and time stamps indicating the execution times are associated with each other. See the following documents, for example.

Japanese Laid-open Patent Publication No. 05-46434

Japanese Laid-open Patent Publication No. 07-191883

Japanese Laid-open Patent Publication No. 09-319617

By using any one of the trace methods discussed in the above documents, the user can acquire trace information in which the line numbers in a source code that correspond to instructions that have already been executed are listed. However, when processing including a loop is performed and trace information is generated as a result, line numbers corresponding to the loop in the source code could repeatedly appear. Thus, a debug method in which the user checks every single source code line indicated by an individual line number in the trace information has a problem that the user cannot easily understand the overall flow of processing including a loop.

### SUMMARY

According to one aspect, there is provided a non-transitory computer-readable storage medium storing a computer program that causes a computer to perform a procedure including: acquiring trace information including a string of location information which indicates locations of texts in a source code that correspond to instructions that have already been executed and which stores an execution order of the instructions; detecting a substring that appears a plurality of times from the string of location information included in the trace information and determining location information that belongs to a loop and an execution status of the loop; and displaying the execution status of the loop and the source code in association with each other, the execution status of the loop and the source code being associated with each other based on the location information that belongs to the loop.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing system;

FIG. 2 is a block diagram illustrating an example of a hardware configuration of a debug device;

FIG. 3 is a block diagram illustrating an example of functions of the debug device;

FIG. 4 illustrates a source file as an example;

FIG. 5 illustrates a trace file and a line information file as examples;

FIG. 6 illustrates a display example of the source code;

FIG. 7 illustrates a different source file as an example;

FIG. 8 illustrates a different trace file and a different line information file as examples;

FIG. 9 illustrates a display example of the different source code;

FIG. 10 is a flowchart illustrating an example of a procedure of debug processing;

FIG. 11 is a flowchart illustrating an example of a procedure of loop detection; and

FIG. 12 is a flowchart illustrating an example of a procedure of display of execution paths.

### DESCRIPTION OF EMBODIMENTS

Hereinafter, embodiments will be described below with reference to the accompanying drawings, wherein like reference characters refer to like elements throughout.

### First Embodiment

A first embodiment will be described.

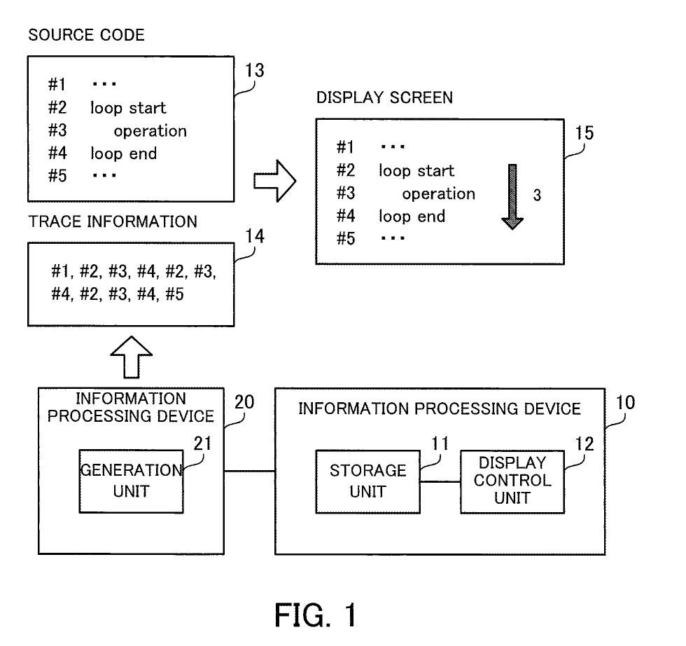

FIG. 1 illustrates an example of an information processing system.

The information processing system according to the first embodiment includes information processing devices 10 and 20. The information processing devices 10 and 20 may be client computers operated by users or server computers accessed by client computers. The information processing devices 10 and 20 are used to assist debug performed in software development. The information processing devices 10 and 20 are connected via a network, for example.

The information processing device 10 includes a storage unit 11 and a display control unit 12. The information processing device 20 includes a generation unit 21. For example, the storage unit 11 may be a volatile storage device such as a random access memory (RAM) or a non-volatile storage device such as a hard disk drive (HDD) or a flash memory. For example, each of the display control unit 12 and generation unit 21 is a processor such as a central processing unit (CPU) or a digital signal processor (DSP). The display control unit and generation unit 21 may include an electronic circuit for specific use such as an application specific integrated circuit (ASIC) or a field programmable gate array (FPGA). These processors execute programs held in a memory such as a RAM. The programs include an execution result display program. A group of processors (multiprocessor) may be referred to as a “processor.”

The generation unit 21 executes instructions generated from the source code 13 and generates trace information 14. The trace information 14 includes a string of location information which indicates locations of texts in the source code 13 that correspond to instructions that have already been executed and which stores an execution order of the instructions. It is fair to say that the string of location information indicates an execution order of the instructions. For example, the location information is listed according to the execution order of the instructions. For example, the line numbers in the source code 13 may be used as the location information. For example, the source code 13 is converted by a compiler into an object code including processor-executable instructions. The compiler may be included in either one of the information processing devices 10 and 20. The compiler generates a debug object code so that location information corresponding to the instructions executed is outputted. For example, when a compile option indicating a debug object code is set, the compiler generates a debug object code.

Since the source code 13 includes texts that indicate a loop, the generation unit 21 executes the loop. In the example in FIG. 1, a text indicating processing outside the loop is written in line #1 in the source code 13. A text indicating the start of the loop is written in line #2. A text indicating processing inside the loop is written in line #3. A text indicating the end of the loop is written in line #4. A text indicating processing outside the loop is written in line #5. The generation unit 21 could repeatedly execute the instructions that correspond to lines #2 to #4 in the source code 13. In the example in FIG. 1, the trace information 14 includes a string of location information #1, #2, #3, #4, #2, #3, #4, #2, #3, #4, and #5. This indicates that the instructions that correspond to lines #2 to #4 have been repeatedly performed three times.

The information processing device 10 acquires the trace information 14 from the information processing device 20. The trace information 14 is transmitted via the network, for example. The storage unit 11 holds the trace information 14 acquired from the information processing device 20. Alternatively, in place of the information processing device 20 different from the information processing device 10, the information processing device 10 may generate the trace information 14. Namely, a processor in the information processing device 10 may execute the instructions generated from the source code 13. In this case, the display control unit 12 may be configured to function as the generation unit 21 and store the generated trace information 14 in the storage unit 11.

The display control unit 12 acquires the trace information 14 from the storage unit 11 and detects a substring that appears a plurality of times from the string of location information included in the trace information 14. For example, from the string of location information #1, #2, #3, #4, #2, #3, #4, #2, #3, #4, and #5, the display control unit 12 detects a substring #2, #3, and #4 that repeatedly appears three times. Based on the detected substring, the display control unit 12 determines location information that belongs to the loop and an execution status of the loop. Examples of the execution status of the loop include the number of repetitions of the loop. For example, the display control unit 12 determines that the location information that belongs to the loop is the substring #2, #3, and #4 and the number of repetitions of the loop is 3.

Next, the display control unit 12 associates, based on the location information that belongs to the loop, the execution status of the loop with the source code 13 and displays the associated information. For example, the display control unit 12 generates a display screen 15 in which the execution status of the loop is associated with the source code 13. On the display screen 15, information that indicates a range of texts that belongs to the loop included in the texts in the source code 13 and the execution status of the loop is displayed. Associated with the range of texts that belongs to the loop, the execution status of the loop is also displayed on the display screen 15. The information that indicates the range of texts that belongs to the loop may be an arrow. In the example in FIG. 1, an arrow covering lines #2 to #4 is displayed, and the number of repetitions “3” is displayed near the arrow. For example, the display screen 15 is displayed on a display of the information processing device 10 or on a display connected to the information processing device 10.

In the information processing system according to the first embodiment, the instructions generated from the source code 13 are executed, and the trace information 14 including a string of location information (for example, a string of line numbers) is generated. A substring that appears a plurality of times is detected from the string of location information included in the trace information 14, and location information that belongs to a loop and an execution status of the loop are determined. In addition, based on the location information that belongs to the loop, the execution status of the loop is associated with the source code 13, and the associated information is displayed. Thus, even when location information that belongs to a loop repeatedly appears in the trace information 14, the user is able to understand the execution status of the loop more easily, compared with a method in which the user checks each text in the source code 13 that corresponds to individual location information. In addition, the user is able to easily understand the overall flow of processing including a loop. As a result, the debug in software development is efficiently performed.

### Second Embodiment

Next, a second embodiment will be described.

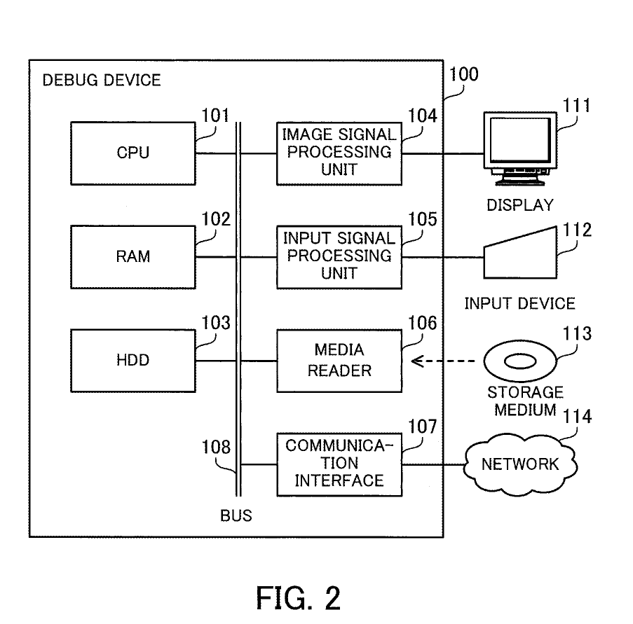

FIG. 2 is a block diagram illustrating an example of a hardware configuration of a debug device 100.

The debug device 100 according to the second embodiment assists debug that developers perform in software development. The debug device 100 includes a CPU 101, a RAM 102, an HDD 103, an image signal processing unit 104, an input signal processing unit 105, a media reader 106, and a communication interface 107. These units are connected to a bus 108.

The CPU 101 is a processor which includes an arithmetic circuit that executes program instructions. The CPU 101 loads at least a part of programs or data held in the HDD 103 to the RAM 102 and executes the program. The CPU 101 may include a plurality of processor cores, and the debug device 100 may include a plurality of processors. The processing described below may be executed in parallel by using a plurality of processors or processor cores. In addition, a group of processors (multiprocessor) may be referred to as a “processor.”

The RAM 102 is a volatile semiconductor memory that temporarily holds a program executed by the CPU 101 or data used by the CPU 101 for calculation. The debug device 100 may include a different kind of memory other than a RAM. The debug device 100 may include a plurality of memories.

The HDD 103 is a non-volatile storage device that holds software programs and data such as an operating system (OS), middleware, or application software. The programs include an execution result display program. The debug device 100 may include a different kind of storage device such as a flash memory or a solid state drive (SSD). The debug device 100 may include a plurality of non-volatile storage devices.

The image signal processing unit 104 outputs an image to a display 111 connected to the debug device 100 in accordance with instructions from the CPU 101. Examples of the display 111 include a cathode ray tube (CRT) display, a liquid crystal display (LCD), a plasma display panel (PDP), and an organic electro-luminescence (OEL) display.

The input signal processing unit 105 acquires an input signal from an input device 112 connected to the debug device 100 and outputs the input signal to the CPU 101. Examples of the input device 112 include a pointing device such as a mouse, a touch panel, a touch pad, or a trackball, a keyboard, a remote controller, and a button switch. A plurality of kinds of input devices may be connected to the debug device 100.

The media reader 106 is a reading device that reads programs or data recorded in a storage medium 113. Examples of the storage medium 113 include a magnetic disk such as a flexible disk (FD) or an HDD, an optical disc such as a compact disc (CD) or a digital versatile disc (DVD), a magneto-optical disk (MO), and a semiconductor memory. For example, the media reader 106 stores a program or data read out from the storage medium 113 in the RAM 102 or the HDD 103.

The communication interface 107 is connected to a network 114 and communicates with other computers via the network 114. The communication interface 107 may be a wired communication interface connected to a communication device such as a switch via a cable or may be a wireless communication interface connected to an access point via a wireless link.

The media reader 106 may be absent in the debug device 100. In addition, when a terminal device operated by a user can access the debug device 100 via the network 114, the image signal processing unit 104 or the input signal processing unit 105 may be absent in the debug device 100. In addition, the display 111 and the input device 112 may be integrated with the enclosure of the debug device 100. The debug device 100 corresponds to the information processing device 10 according to the first embodiment. The RAM 102 or the HDD 103 corresponds to the storage unit 11 according to the first embodiment. The CPU 101 corresponds to the display control unit 12 according to the first embodiment.

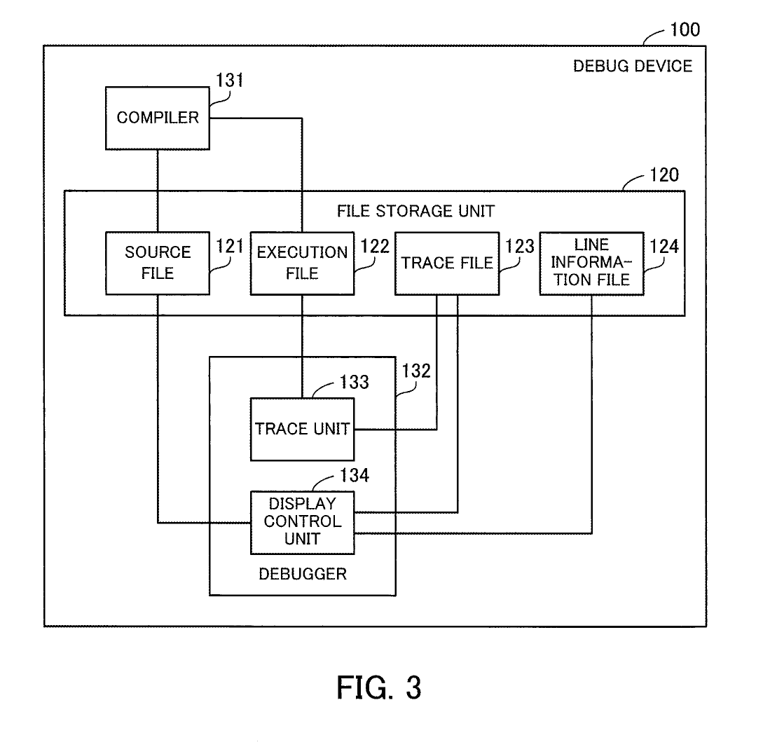

FIG. 3 is a block diagram illustrating an example of functions of the debug device 100.

The debug device 100 includes a file storage unit 120, a compiler 131, and a debugger 132. The file storage unit 120 may be realized as a storage area ensured in the RAM 102 or the HDD 103. The compiler 131 and the debugger 132 may be realized as program modules executed by the CPU 101.

The file storage unit 120 includes a source file 121, an execution file 122, a trace file 123, and a line information file 124.

The source file 121 includes a source code created by a user. The source code is written in a high-level language that is easily understood by humans, such as Fortran or the C language. The execution file 122 includes an object code that corresponds to the source file 121. The object code includes instructions executable by the CPU 101 (machine-readable instructions). The trace file 123 includes trace information indicating a result obtained by execution of the object code included in the execution file 122. The trace information includes a string of line numbers in the source code that corresponds to a string of instructions executed. The line information file 124 includes line information indicating the execution paths on the source code. The line information is obtained by summarizing the trace information held in the trace file 123 and is expressed by line numbers in the source code.

The compiler 131 reads out the source file 121 from the file storage unit 120 and compiles the source code included in the source file 121. The compiler 131 generates a machine-readable object code by this compiling and stores the execution file 122 including the object code in the file storage unit 120. In the second embodiment, when the compiler 131 is activated, a debug mode is set to the compiler 131 as a compile option. When the debug mode is set, the compiler 131 generates a debug object code. The debug object code includes a function of outputting the line numbers in the source code that correspond to the instructions executed.

The debugger 132 assists in debugging the source code included in the source file 121. The debugger 132 includes a trace unit 133 and a display control unit 134.

The trace unit 133 reads out the execution file 122 from the file storage unit 120 and executes the object code included in the execution file 122. As described above, since this object code is a debug object code, the line numbers in the source code that correspond to the instructions executed are sequentially outputted. The trace unit 133 generates the trace file 123 on the file storage unit 120 and sequentially writes the line numbers outputted by the execution of the object code in the trace file 123. Consequently, a string of line numbers corresponding to a string of instructions executed is written in the trace file 123.

The display control unit 134 reads out the source file 121 from the file storage unit 120 and displays the source code included in the source file 121 on the display 111. In addition, the display control unit 134 reads out the trace file 123 from the file storage unit 120, generates line information by analyzing the trace information included in the trace file 123, and stores the line information file 124 including the line information in the file storage unit 120. Next, the display control unit 134 superimposes the execution paths indicated by the line information on the source code on the display 111.

When generating the line information, the display control unit 134 detects a substring that repeatedly appears from the string of line numbers indicated by the trace information. If the same substring consecutively appears a plurality of times, the display control unit 134 determines this substring to be a string of line numbers that belongs to a loop and converts these repetitive portions into a set of a single substring and the number of times that the substring appears (namely, the number of repetitions of the loop). When displaying the execution paths, the display control unit 134 expresses consecutive line numbers that do not belong to a loop as a single arrow. When expressing consecutive line numbers that belong to a loop as a single arrow, the display control unit 134 displays a value indicating the number of repetitions of the loop near the arrow. In this way, whether line numbers belong to a loop or not, the execution paths on the source code are expressed in a concise way.

In the second embodiment, the compilation of the source code, the execution of the object code, and the visualization of the trace result are all performed by the debug device 100. However, part of the above processing may be executed by a different computer. For example, the execution of the object code and the visualization of the trace result may be performed by different computers. In this case, the trace unit 133 and the display control unit 134 are provided in different computers. The compiler 131 may be provided in the same computer including the trace unit 133 or in the same computer including the display control unit 134. When a plurality of computers are used, at least one of the source file 121, the execution file 122, and the trace file 123 may be held in a storage device accessible by the plurality of computers.

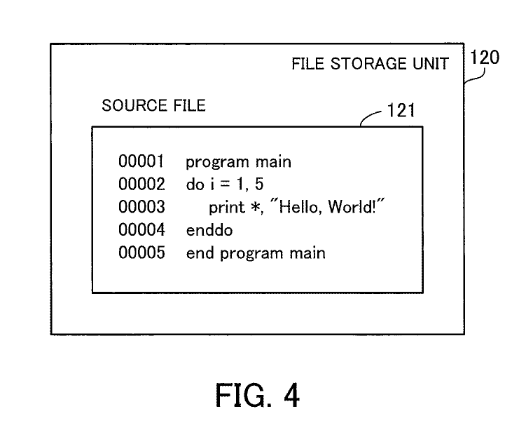

FIG. 4 illustrates a source file as an example.

The source file 121 held in the file storage unit 120 includes five lines 00001 to 00005, for example. As an example, a text indicating the start of a main function is written in line 00001. A text indicating the start of a loop and indicating that a loop variable i sequentially changes from 1 to 5 is written in line 00002. A text indicating processing for displaying a character string “Hello, World!” is written in line 00003. A text indicating the end of the loop is written in line 00004. A text indicating the end of the main function is written in line 00005. These line numbers may or may not be included in the source code. When the line numbers are not included in the source code, the line numbers are sequentially counted from the beginning of the source file 121.

When the main function written in the source file 121 is executed, first, the instruction corresponding to line 00001 is executed. Next, the instructions corresponding to lines 00002 to 00004 are sequentially executed in this order. Since the string of instructions corresponding to lines 00002 to 00004 forms a loop, the instruction corresponding to line 00002 is executed again after the instruction corresponding to line 00004 is executed. In this way, the string of instructions corresponding to lines 00002 to 00004 is repeatedly performed five times. After the string of instructions corresponding to lines 00002 to 00004 is executed five times, the instruction corresponding to line 00005 is finally executed.

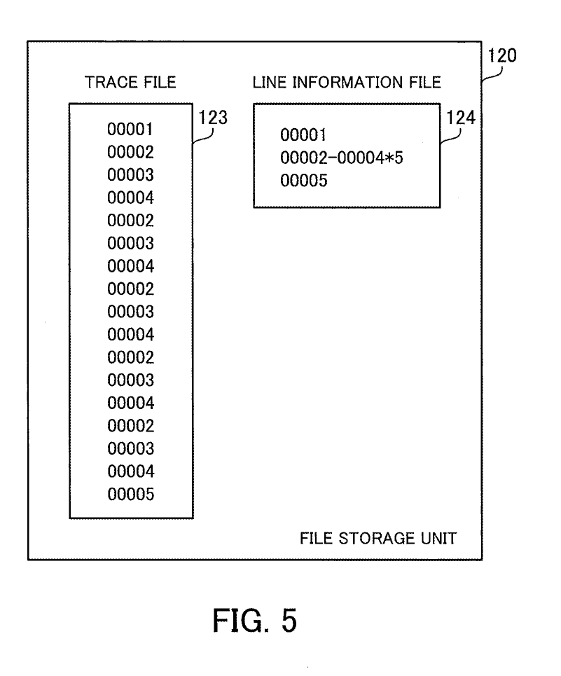

FIG. 5 illustrates a trace file and a line information file as examples.

When the object code included in the execution file 122 generated from the source file 121 is executed, the trace file 123 as illustrated in FIG. 5 is generated. The trace file 123 is stored in the file storage unit 120. The trace file 123 includes 17 line numbers, for example. The line numbers included in the trace file 123 are listed in the order corresponding to the instruction execution order of the object code.

As an example, “00001” is written at the beginning in the trace file 123. After “00001,” a string of line numbers “00002,” “00003,” and “00004” is repeatedly written five times in the trace file 123. This indicates that the texts corresponding to lines 00002 to 00004 in the source code indicate a loop and signifies that the string of instructions corresponding to lines 00002 to 00004 is repeatedly executed five times. Finally, “00005” is written in the trace file 123.

The line information file 124 is generated on the basis of the above trace file 123. The line information file 124 is held in the file storage unit 120. The line information file 124 includes at least one entry in which the string of line numbers written in the trace file 123 is summarized. A single entry included in the line information file 124 may indicate a string of consecutive line numbers. When the trace result is visualized, a single entry in the line information file 124 may be expressed as an arrow indicating an execution path on the source code.

As an example, “00001” is written at the beginning in the line information file 124. After “00001,” “00002-00004#5” is written in the line information file 124. This indicates that the instructions corresponding to lines 00002 to 00004 have been sequentially executed. This also indicates that the string of instructions is repeatedly executed five times. This entry “00002-00004#5” is generated by summarizing the 15 consecutive line numbers “00002,” “00003,” “00004,” “00002,” . . . , and “00004” included in the trace file 123. Finally, “00005” is written in the line information file 124.

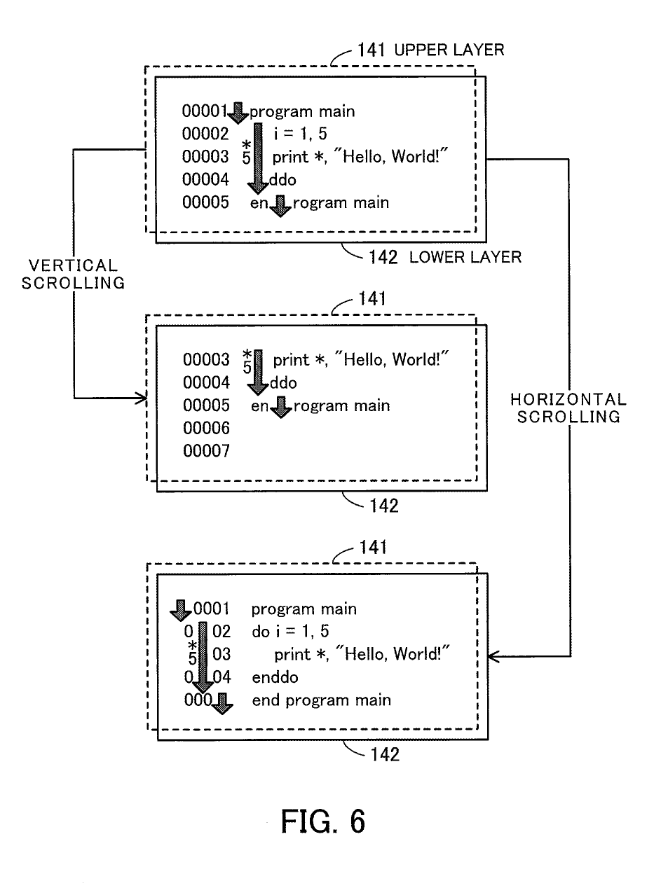

FIG. 6 illustrates a display example of the source code.

When visualizing the trace result, the display control unit 134 superimposes an upper layer 141 on a lower layer 142 on the display 111. The arrows indicating the execution paths and the number of executions of the loop are displayed on the upper layer 141 on the basis of the line information file 124. The source code included in the source file 121 is displayed on the lower layer 142.

More specifically, for each entry included in the line information file 124, a vertical arrow indicating at least one line number is displayed on the upper layer 141. If an entry includes a repetition number, a value indicating the repetition number is displayed near the corresponding arrow. When a plurality of arrows corresponding to a plurality of entries included in the line information file 124 are displayed, these arrows are displayed from left to right. For example, three arrows are displayed on the upper layer 141. The first arrow from the left covers line 00001. The second arrow from the left cover lines 00002 to 00004. The repetition number “5” is displayed near the second arrow from the left. The third arrow from the left covers line 00005.

The arrows on the upper layer 141 and the source code on the lower layer 142 are associated with each other by the line numbers. When the source code is long, only some texts corresponding to some of the lines in the source code may be displayed on the display 111. In this case, the user may vertically scroll the lower layer 142 by using the input device 112. When the user performs this operation, the corresponding arrows on the upper layer 141 also move vertically in coordination with the source code on the lower layer 142. When the source code is long, only some of the plurality of arrows may be displayed on the display 111. In this case, the user may horizontally scroll the upper layer 141 by using the input device 112. When the user performs this operation, the corresponding arrows on the upper layer 141 horizontally move independently of the lower layer 142.

Namely, when the user performs vertical scrolling, the upper layer 141 and the lower layer 142 move in coordination with each other. When the source code on the lower layer 142 vertically moves, the corresponding arrows on the upper layer 141 also move vertically. However, when the user performs horizontal scrolling, the upper layer 141 and the lower layer 142 do not move in coordination with each other. While only the corresponding arrows on the upper layer 141 move horizontally, the source code on the lower layer 142 does not move horizontally. In this way, even when many arrows are displayed from left to right, the user is able to easily understand the relationship between the arrows and the source code.

The above description has been made on the assumption that the debug device 100 visualizes a trace result obtained when the source code includes a single loop. However, even when the source code includes a multiple loop, the debug device 100 is able to visualize the obtained trace result in a concise way.

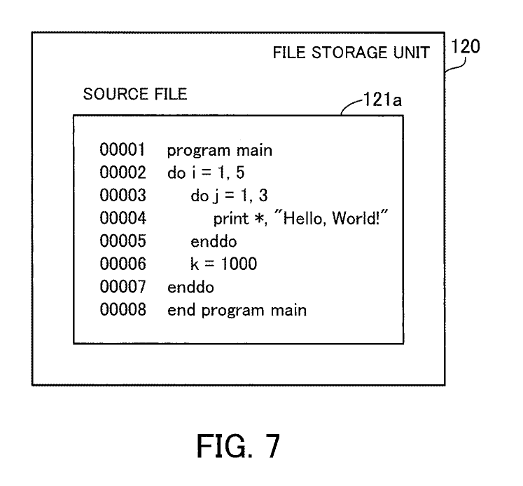

FIG. 7 illustrates a different source file as an example.

The following description will be made assuming that, instead of the source file 121, a source file 121a is held in the file storage unit 120. The source file 121a held in the file storage unit 120 includes eight lines 00001 to 00008. As an example, a text indicating the start of a main function is written in line 00001. A text indicating the start of an outer loop and indicating that a loop variable i sequentially changes from 1 to 5 is written in line 00002. A text indicating the start of an inner loop and indicating that a loop variable j sequentially changes from 1 to 3 is written in line 00003.

A text indicating processing for displaying a character string “Hello, World!” is written in line 00004. The processing indicated by the text in line 00004 belongs to the inner loop. A text indicating the end of the inner loop is written in line 00005. A text indicating processing for assigning 1000 to a variable k is written in line 00006. The processing indicated by the text in line 00006 belongs to the outer loop, not to the inner loop. A text indicating the end of the outer loop is written in line 00007. A text indicating the end of the main function is written in line 00008.

When the main function written in the source file 121a is executed, first, the instruction corresponding to line 00001 is executed. Next, the instructions corresponding to lines 00002 to 00005 are sequentially executed in this order. Since the string of instructions corresponding to lines 00003 to 00005 forms the inner loop, the instruction corresponding to line 00003 is performed again after the instruction corresponding to line 00005 is executed. In this way, the string of instructions corresponding to lines 00003 to 00005 is repeatedly executed three times.

After the string of instructions corresponding to lines 00003 to 00005 is executed three times, the instructions corresponding to lines 00006 and 00007 are sequentially executed. Since the string of instructions corresponding to lines 00002 to 00007 forms the outer loop, the instruction corresponding to line 00002 is executed again after the instruction corresponding to line 00007 is executed. Next, the string of instructions corresponding to lines 00003 to 00005 is repeatedly executed three times. In this way, the string of instructions corresponding to lines 00002, 00006, and 00007 is repeatedly executed five times. Each time this set of instructions is executed, the string of instructions corresponding to lines 00003 to 00005 is executed three times. After the processing of the outer loop is executed five times, the instruction corresponding to line 00008 is executed finally.

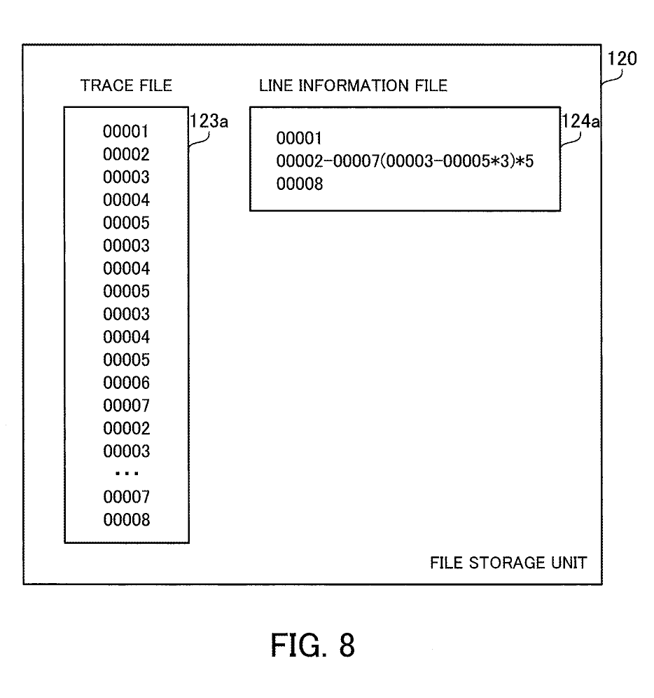

FIG. 8 illustrates a different trace file and a different line information file as examples.

When the object code included in the execution file generated from the source file 121a is executed, a trace file 123a as illustrated in FIG. 8 is generated. For example, the trace file 123a includes 62 line numbers.

As an example, “00001” is written at the beginning in the trace file 123a. In the trace file 123a, “00002” is written after “00001.” Next, a string of line numbers “00003,” “00004,” and “00005” is repeatedly written three times after “00002.” This indicates that the string of lines 00003 to 00005 forms an inner loop and that the loop is repeatedly executed three times. In the trace file 123a, “00006” and “00007” are written after “00005.” In the trace file 123a, the string of these 12 line numbers from “00002” to “00007” repeatedly appears five times. This indicates that the string of lines 00002 to 00007 forms an outer loop and the outer loop is repeated five times. Finally, “00008” is written in the trace file 123a.

On the basis of the trace file 123a, a line information file 124a is generated. The line information file 124a includes at least one entry in which the string of line numbers written in the trace file 123a is summarized. A single entry included in the line information file 124a may indicate a string of consecutive line numbers. When a multiple loop exists, a single entry in the line information file 124a may correspond to a single outer loop. Namely, a single entry in the line information file 124a may include information that indicates the range of an inner loop.

As an example, “00001” is written at the beginning in the line information file 124a. In the line information file 124a, “00002-00007(00003-00005#3)#5” is written after “00001.” The outer loop “00002-00007#5” in this entry indicates that the string of instructions corresponding to lines 00002 to 00007 has repeatedly been executed five times. In addition, the inner loop “00003-00005#3” in this entry indicates that the string of instructions corresponding to the range of lines 00003 to 00005 has been repeatedly executed three times per repetition of the outer loop. Finally, “00008” is written in the line information file 124a.

The inner loop “00003-00005#3” is generated by summarizing the 9 consecutive line numbers of “00003,” “00004,” “00005,” “00003,” “00005” included in the trace file 123a. In addition, the outer loop “00002-00007#5” is generated by further summarizing the string “00002,” “00003-00005#3,” “0006,” “00007,” “00002,” “00007” after the inner loop detection result is received. Namely, an entry indicating a multiple loop in the line information file 124a is generated by first summarizing the range of consecutive line numbers of an inner loop and the number of repetitions of the inner loop.

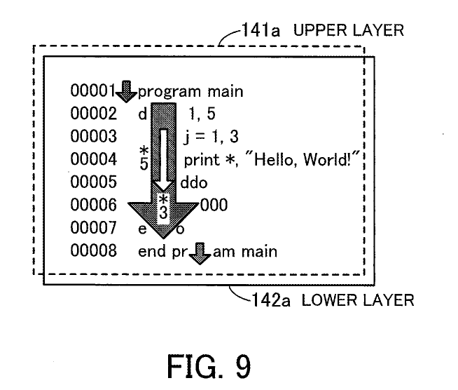

FIG. 9 illustrates a display example of the different source code.

The display control unit 134 superimposes an upper layer 141a on a lower layer 142a on the display 111. The arrows indicating the execution paths and the number of executions of an individual loop are displayed on the upper layer 141a on the basis of the line information file 124a. The source code included in the source file 121a is displayed on the lower layer 142a.

When the line information file 124a includes an entry that indicates hierarchical ranges of line numbers, hierarchical arrows are displayed on the upper layer 141a. Namely, first, an arrow corresponding to the inner loop is displayed on the upper layer 141a, and next, an arrow corresponding to the outer loop is displayed in such a manner that this arrow contains the arrow corresponding to the inner loop. The number of repetitions of the inner loop is displayed near the arrow corresponding to the inner loop, and the number of repetitions of the outer loop is displayed near the arrow corresponding to the outer loop. The number of repetitions of the inner loop may be displayed inside the arrow corresponding to the outer loop.

For example, three arrows are displayed on the upper layer 141a. The first arrow from the left covers line 00001. The second arrow from the left covers lines 00002 to 00007. The number of repetitions “5” is displayed near the second arrow from the left. In addition, the second arrow from the left includes an arrow that covers lines 00003 to 00005. The number of repetitions “3” is displayed near the inner arrow. Namely, the arrow corresponding to lines 00002 to 00007 indicates the outer loop, and the arrow corresponding to lines 00003 to 00005 indicates the inner loop. The third arrow from the left covers line 00008. The arrows on the upper layer 141a are associated with the source code on the lower layer 142a by the line numbers.

Next, a procedure of processing performed by the debug device 100 will be described. The following description will be made assuming that the source file 121, the trace file 123, and the line information file 124 are used. However, in place of these files, the source file 121a, the trace file 123a, and the line information file 124a may alternatively be used.

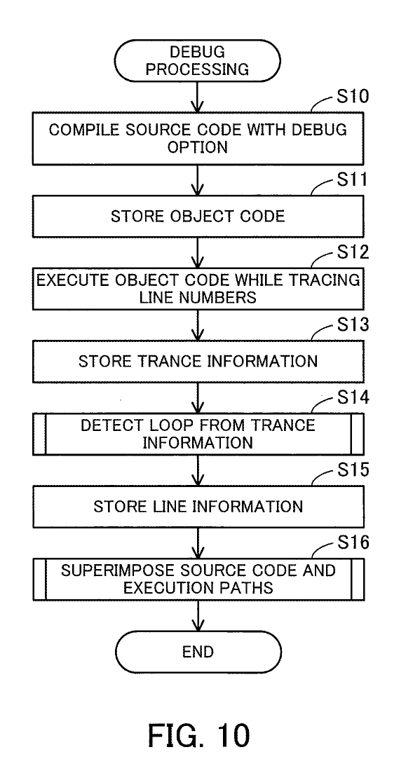

FIG. 10 is a flowchart illustrating an example of a procedure of debug processing.

(S10) The compiler 131 receives a compile command in which a debug mode is set as a compile option. The compile command may be inputted by the user or the debugger 132. The compiler 131 reads out the source file 121 from the file storage unit 120 and compiles the source code included in the source file 121. In this compiling, a debug function is implemented so that line numbers in the source code corresponding to executed instructions can be outputted.

(S11) The compiler 131 generates an object code corresponding to the source code as a compilation result. The compiler 131 generates the execution file 122 including the object code and stores the execution file 122 in the file storage unit 120.

(S12) The trace unit 133 reads out the execution file 122 from the file storage unit 120 and executes the object code included in the execution file 122. A debug function is implemented in this object code. Thus, the trace unit 133 sequentially acquires the line numbers in the source code corresponding to the machine-readable instructions.

(S13) The trace unit 133 generates the trace file 123 including trace information and stores the trace file 123 in the file storage unit 120. In the trace information, a plurality of line numbers acquired by the execution of the object code are listed in the order of the acquisition.

(S14) The display control unit 134 reads out the trace file 123 from the file storage unit 120. The display control unit 134 detects a loop from the trace information included in the trace file 123. More specifically, from the string of line numbers indicated by the trace information, the display control unit 134 calculates line numbers that belong to a loop and the number of repetitions of the loop. The loop could be a multiple loop. This loop detection will be described in detail below.

(S15) The display control unit 134 generates line information from the trace information by summarizing and converting the string of line numbers about the detected loop into a concise expression. The display control unit 134 generates the line information file 124 including the line information and stores the line information file 124 in the file storage unit 120.

(S16) The display control unit 134 reads out the source file 121 and the line information file 124 from the file storage unit 120 and visualizes the line information included in the line information file 124. More specifically, the display control unit 134 displays the source code included in the source file 121 on the display 111. In addition, the display control unit 134 superimposes information about the execution paths indicated by the line information on the source code on the display 111. The information about the execution paths includes the arrows indicating the ranges of the line numbers in the source code that correspond to the string of executed instructions and the value indicating the number of repetitions of the loop. How the execution paths are displayed will be described in detail below

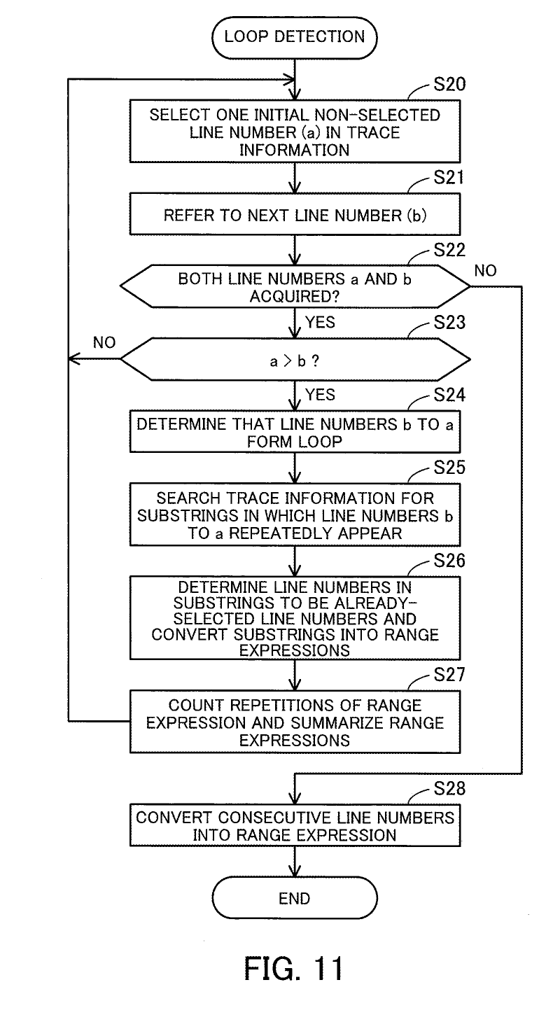

FIG. 11 is a flowchart illustrating an example of a procedure of loop detection.

This loop detection is executed in the above step S14.

(S20) The display control unit 134 selects one initial non-selected line number in the trace information (the line number that has been outputted first). Hereinafter, the selected line number will be expressed as “line number a.”

(S21) The display control unit 134 refers to the next line number of the line number a in the trace information. This line number that the display control unit 134 refers to will be expressed as “line number b.”

(S22) The display control unit 134 determines whether both the line numbers a and b have been acquired. If there are not any non-selected line numbers in step S20, the display control unit 134 fails to acquire the line number a. If the next line number of the line number a does not exist in step S21 (if the acquisition of the line number a fails or if the line number a is the end in the trace information), the display control unit 134 fails to acquire the line number b. If the display control unit 134 has acquired both the line numbers a and b, the operation proceeds to step S23. Otherwise, the operation proceeds to step S28.

(S23) The display control unit 134 compares the line number a with the line number b and determines whether the line number a is larger than the line number b. If the line number a is larger than the line number b, the operation proceeds to step S24. Otherwise, the operation proceeds to step S20.

(S24) The display control unit 134 determines the range of texts from the line number b to the line number a in the source code to be texts indicating a loop.

(S25) The display control unit 134 searches the string of line numbers indicated in the trace information for substrings in which the range of texts from the line numbers b to a repeatedly appears.

(S26) The display control unit 134 determines the line numbers included in the found substrings to be line numbers that have already been selected in step S20. Each of the found substrings is expressed as a list of all the line numbers belonging to the loop. The display control unit 134 converts these substrings into a range expression using the line number b as the start line and the line number a as the end line. If a substring includes line numbers that have already been converted into a range expression, the inner range expression indicates an inner loop, and the range expression that is currently being generated indicates an outer loop. In this case, the inner range expression is also noted.

(S27) The display control unit 134 counts how many times the same range expression repeatedly appears and summarizes and converts the consecutive range expressions into a set of a single range expression and the number of repetitions of the loop. Next, the operation proceeds to step S20.

(S28) Among the line numbers included in the trace information, regarding the line numbers that have not been converted into any range expression in step S26 or S27, namely, the line numbers that do not belong to any loop, the display control unit 134 converts the consecutive line numbers into a range expression. Through the conversion in steps S26, S27, and S28, the entries in the line information file 124 are generated.

For example, in the case of the trace file 123 illustrated in FIG. 5, first, the display control unit 134 selects “00001” as the line number a and refers to “00002” as the line number b. Since b is larger than a, the display control unit 134 does not detect a loop. Next, the display control unit 134 selects “00002” as the line number a and refers to “00003” as the line number b. Next, the display control unit 134 selects “00003” as the line number a and refers to “00004” as the line number b. Since b has always been larger than a up until this point, the display control unit 134 has not detected any loop yet. Next, the display control unit 134 selects “00004” as the line number a and refers to “00002” as the line number b. Since a is larger than b, the display control unit 134 determines that the string of lines 00002 to 00004 forms a loop.

Next, the display control unit 134 detects substrings each from “00002” to “00004” from the trace file 123 and converts each of the substrings into a range expression “00002-00004.” Consequently, the substring “00002-00004” consecutively appears five times. Thus, the display control unit 134 converts the five consecutive substrings “00002-00004” into “00002-00004#5.” Next, since the substrings each from “00002” to “00004” have been excluded, the display control unit 134 selects “00005” as the line number a. Since the line number a is the end in the trace file 123, the display control unit 134 does not refer to any line number as the line number b. Thus, the display control unit 134 ends the loop detection processing. In this way, the display control unit 134 generates the line information file 124 indicating “00001,” “00002-00004#5,” and “00005.”

In the case of the trace file 123a illustrated in FIG. 8, the display control unit 134 selects “00001” as the line number a and refers to “00002” as the line number b. Since b is larger than a, the display control unit 134 does not detect a loop. Next, the display control unit 134 selects “00002” as the line number a and refers to “00003” as the line number b. Next, the display control unit 134 selects “00003” as the line number a and refers to “00004” as the line number b. Next, the display control unit 134 selects “00004” as the line number a and refers to “00005” as the line number b. Since b has always been larger than a up until this point, the display control unit 134 has not detected any loop yet. Next, the display control unit 134 selects “00005” as the line number a and refers to “00003” as the line number b. Since a is larger than b, the display control unit 134 determines that the string of lines 00003 to 00005 forms a loop.

Next, the display control unit 134 detects substrings each from “00003” to “00005” from the trace file 123a and converts each of the substrings into a range expression “00003-00005.” Consequently, the substring “00003-00005” consecutively appears three times. Thus, the display control unit 134 converts the three consecutive substrings “00003-00005” into “00003-00005#3.” At this point, “00001,” “00002,” “00003-00005#3,” “00006,” “00007,” “00002,” “00003-00005#3,” . . . , “00007,” and “00008” are written in the trace file 123a.

Next, since the substrings each from “00003” to “00005” have been excluded, the display control unit 134 selects “00006” as the line number a and refers to “00007” as the line number b. Since b is larger than a, the display control unit 134 does not detect a loop. Next, the display control unit 134 selects “00007” as the line number a and refers to “00002” as the line number b. Since a is larger than b, the display control unit 134 determines that the string of lines 00002 to 00007 forms a loop. Next, the display control unit 134 detects substrings each from “00002” to “00007” from the trace file 123a. Each of the detected substrings includes “00003-00005#3,” which has already been converted into a range expression. Thus, the display control unit 134 converts each of the substrings into a hierarchical range expression “00002-00007(00003-00005#3).”

Namely, “00002-00007(00003-00005#3)” consecutively appears five times. Thus, the display control unit 134 converts five consecutive “00002-00007(00003-00005#3)” into “00002-00007(00003-00005#3)#5.” Next, since the substrings each from “00002” to “00007” have been excluded, the display control unit 134 selects “00008” as the line number a. Since the line number a is the end in the trace file 123a, the display control unit 134 does not refer to any line number as the line number b. Thus, the display control unit 134 ends the loop detection processing. In this way, the display control unit 134 generates the line information file 124a indicating “00001,” “00002-00007(00003-00005#3)#5,” and “00008.”

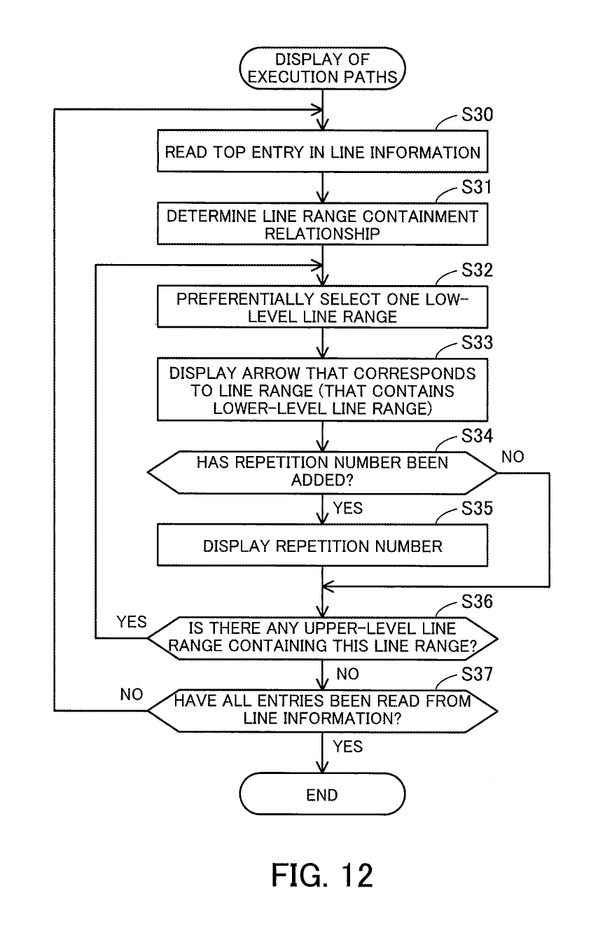

FIG. 12 is a flowchart illustrating an example of a procedure of display of execution paths.

This display of execution paths is executed in the above step S16.

(S30) The display control unit 134 reads the top entry in the line information.

(S31) The display control unit 134 determines the line range containment relationship of the entry read in step S30. Namely, the display control unit 134 determines whether the entry indicates a single line or a range of a plurality of lines. If the entry indicates a range of a plurality of lines, the display control unit 134 determines whether a repetition number is added to the line range. If a repetition number is added to the line range, the display control unit 134 determines whether the entry includes a lower-level line range contained in the line range. The display control unit 134 extracts each of the line ranges in the hierarchical structure and the repetition numbers from the entry and understands the containment relationship.

(S32) The display control unit 134 preferentially selects a lower-level line range from the extracted line ranges. The term “line range” may include a single line.

(S33) The display control unit 134 displays a vertical arrow covering the selected line range on the upper layer 141. The coordinates in the vertical direction of the displayed arrow are calculated in such a manner that the coordinates correspond to the corresponding line numbers in the source code displayed on the lower layer 142. The coordinates in the horizontal direction of the displayed arrow are calculated in such a manner that the arrow is displayed on the left edge or the right side of an arrow displayed immediately before the arrow. Regarding the entry read in step S30, if a lower-level arrow corresponding to a lower-level line range already exists, the display control unit 134 displays the current arrow to cover the lower-level arrow.

(S34) The display control unit 134 determines whether a repetition number has been added to the line range selected in step S32. If so, the operation proceeds to step S35. Otherwise, the operation proceeds to step S36.

(S35) The display control unit 134 displays the repetition number near the arrow displayed on the upper layer 141 in step S33. For example, the display control unit 134 displays the repetition number at a location away from the arrow by a predetermined distance in a predetermined direction.

(S36) The display control unit 134 determines whether any upper-level line range containing the line range selected in step S32 exists on the basis of the containment relationship determined in step S31. If such an upper-level line range exists, the operation proceeds to step S32 in which the display control unit 134 selects the next upper-level line range. If there is no upper-level line range, the operation proceeds to step S37.

(S37) The display control unit 134 determines whether all entries have been read from the line information in step S30. If the display control unit 134 has read all entries, the display control unit 134 ends the execution path display processing. Otherwise, the operation returns to step S30.

For example, if the line information file 124 illustrated in FIG. 5 is generated, first, the display control unit 134 reads “00001” and displays an arrow covering line 00001 on the left edge of the upper layer 141. Next, the display control unit 134 reads “00002-00004#5” and displays an arrow covering lines 00002 to 00004 in the second column from the left edge of the upper layer 141. The display control unit 134 also displays the repetition number “5” near this arrow. Next, the display control unit 134 reads “00005” and displays an arrow covering line 00005 in the third column from the left edge of the upper layer 141.

If the line information file 124a illustrated in FIG. 8 is generated, first, the display control unit 134 reads “00001” and displays an arrow covering line 00001 on the left edge of the upper layer 141a. Next, the display control unit 134 reads “00002-00007(00003-00005#3)#5” and displays an arrow covering lines 00003 to 00005 in the second column from the left edge of the upper layer 141a. The display control unit 134 also displays the repetition number “3” near this arrow. In addition, the display control unit 134 displays an arrow covering lines 00002 to 00007 in such a manner that this arrow contains the above arrow. The display control unit 134 also displays the repetition number near this newly generated arrow. Next, the display control unit 134 reads “00008” and displays an arrow covering line 00008 in the third column from the left edge of the upper layer 141a.

The debug device 100 according to the second embodiment generates a debug object code that outputs line numbers in a source code that correspond to executed instructions. When executing this object code, the debug device 100 generates trace information in which the line numbers have been traced. The debug device 100 is able to detect a loop from the string of line numbers indicated by the trace information. When detecting a loop, the debug device 100 displays an arrow covering the range of lines executed and the number of repetitions of the loop. In this way, even when line numbers that belong to a loop repeatedly appear in the trace information, the user is able to understand the execution status of the loop more easily, compared with a method in which the user checks each text in the source code that corresponds to a line number tranced. In addition, the user is able to easily understand the execution paths.

Thus, the user is able to efficiently perform debug in software development. When there is a multiple loop, an arrow corresponding to an outer loop is displayed in such a manner that this arrow contains an arrow corresponding to an inner loop. Thus, since the execution status of a multiple loop is expressed in a concise way, the user is able to easily understand the execution status. In addition, the execution paths and the source code are displayed in their respective layers. While the two layers vertically move in coordination with each other, the layer for the execution paths horizontally moves independently of the layer for the source code. In this way, even when many arrows are displayed on the layer for the execution paths, the user is able to easily understand the correspondence relationship between the arrows and the line numbers.

The information processing according to the first embodiment may be realized by causing the information processing devices 10 and 20 to execute a program. The information processing according to the second embodiment may be realized by causing the debug device 100 to execute a program.

An individual program may be recorded in a computer-readable storage medium (for example, the storage medium 113). Examples of the storage medium include a magnetic disk, an optical disc, a magneto-optical disk, and a semiconductor memory. Examples of the magnetic disk include an FD and an HDD. Examples of the optical disc include a CD, a CD-R (Recordable)/RW (Rewritable), a DVD, and a DVD-R/RW. The program may be recorded in a portable storage medium and then distributed. In this case, the program may be copied from the portable storage medium to a different storage medium such as an HDD (for example, the HDD 103), and the copied program may be executed.

According to one aspect, the user is able to easily understand the flow of processing including loops.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention.

Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a procedure comprising:
acquiring trace information including a string of location information which indicates locations of texts in a source code that correspond to instructions that have already been executed and which stores an execution order of the instructions;
detecting a substring that appears a plurality of times from the string of location information included in the trace information and determining location information that belongs to a loop and an execution status of the loop; and
displaying the execution status of the loop and the source code in association with each other, the execution status of the loop and the source code being associated with each other based on the location information that belongs to the loop.

2. The non-transitory computer-readable storage medium according to claim 1, wherein when the execution status of the loop is displayed, information that indicates a range of texts in the source code that belongs to the loop and the number of repetitions of the loop are displayed.

3. The non-transitory computer-readable storage medium according to claim 2, wherein, when a different loop that includes the loop exists, the information that indicates the range of texts that belongs to the loop, the number of repetitions of the loop, information that indicates a range of texts that belongs to the different loop, and the number of repetitions of the different loop are displayed hierarchically.

4. An information processing apparatus comprising:
a memory configured to store trace information including a string of location information which indicates locations of texts in a source code that correspond to instructions that have already been executed and which stores an execution order of the instructions; and
a processor configured to perform a procedure including:
detecting a substring that appears a plurality of times from the string of location information included in the trace information and determining location information that belongs to a loop and an execution status of the loop; and
displaying the execution status of the loop and the source code in association with each other, the execution status of the loop and the source code being associated with each other based on the location information that belongs to the loop.

5. An information processing system comprising:
a first information processing apparatus configured to execute instructions generated from a source code and generate trace information including a string of location information which indicates locations of texts in the source code that correspond to the instructions that have already been executed and which stores an execution order of the instructions; and
a second information processing apparatus configured to acquire the generated trace information, detect a substring that appears a plurality of times from the string of location information included in the trace information, determine location information that belongs to a loop and an execution status of the loop, and display the execution status of the loop and the source code in association with each other, the execution status of the loop and the source code being associated with each other based on the location information that belongs to the loop.
